(19) United States
(12) Patent Application Publication
(10) Pub. No.: US 2025/0268391 A1
(43) Pub. Date: Aug. 28, 2025

(54) Tapered Exhaust Port for Valve Manifold

(71) Applicant: Sleep Number Corporation, Minneapolis, MN (US)

(72) Inventor: Brian Doffing, Arden Hills, MN (US)

(21) Appl. No.: 19/053,575

(22) Filed: Feb. 14, 2025

Related U.S. Application Data
(60) Provisional application No. 63/557,831, filed on Feb. 26, 2024.

(51) Int. Cl. A47C 27/08

(52) U.S. Cl. CPC A47C 27/082; A47C 27/083

(57) ABSTRACT

A bed system having a mattress, a pump, and a valve manifold. The mattress has at least one inflatable chamber. The valve manifold has a manifold housing, an inlet port, an outlet port, and an exhaust port. The manifold housing defines a manifold interior. The inlet port passes through the manifold housing. The inlet port conducts fluid from the pump to the manifold interior. The outlet port passes through the manifold housing. The outlet port conducts fluid from the manifold interior to and from the at least one inflatable chamber. The exhaust port passes through the manifold housing. The exhaust port defines a passage having a passage inlet and a passage outlet. The passage outlet is smaller than the passage inlet.

### CROSS-REFERENCE TO RELATED APPLICATIONS

This application claims the benefit of U.S. Provisional Application Ser. No. 63/557,831, filed Feb. 26, 2024. The disclosure of the prior application is considered part of the disclosure of this application, and is incorporated in its entirety into this application.

### TECHNICAL FIELD

This invention relates to valves, and more particularly to valve manifolds for use in beds.

### BACKGROUND

People have traditionally used beds that come in many shapes, sizes, and styles. Such beds can range from extremely simple designs to rather complex designs that include a variety of features. For example, some beds can have one or more inflatable chambers or foam air chambers. Some of such beds can include an inflation system including a number of mechanical and electrical components. For example, some beds can include one or more pumps with valve manifolds having one or more valves for inflating the chambers.

### SUMMARY

Some embodiments of a pump system can include one or more of the features and functions disclosed herein. Some embodiments can include a solenoid valve with one or more means for reducing noise during actuation of the valve. A bed system can have a mattress, a pump, and a valve manifold. The mattress has at least one inflatable chamber. The valve manifold has a manifold housing, an inlet port, an outlet port, and an exhaust port. The manifold housing defines a manifold interior. The inlet port passes through the manifold housing. The inlet port conducts fluid from the pump to the manifold interior. The outlet port passes through the manifold housing. The outlet port conducts fluid from the manifold interior to and from the at least one inflatable chamber. The exhaust port passes through the manifold housing. The exhaust port defines a passage having a passage inlet and a passage outlet. The passage outlet is smaller than the passage inlet.

This can be particularly desirable in inflatable beds where noise can be undesirable, especially during sleep of a user. Various embodiments can be configured with components having particular shapes and features.

In one aspect, a bed system includes a mattress, a pump, and a valve manifold. The mattress has at least one inflatable chamber. The valve manifold has a manifold housing, an inlet port, an outlet port, and an exhaust port. The manifold housing defines a manifold interior. The inlet port passes through the manifold housing. The inlet port conducts fluid from the pump to the manifold interior. The outlet port passes through the manifold housing. The outlet port conducts fluid from the manifold interior to and from the at least one inflatable chamber. The exhaust port passes through the manifold housing. The exhaust port defines a passage having a passage inlet and a passage outlet. The passage outlet is smaller than the passage inlet.

In another aspect combinable with any other aspect, the passage has a frustoconical volume.

In another aspect combinable with any other aspect, the passage includes a first portion and a second portion.

In another aspect combinable with any other aspect, the first portion of the passage has a cylindrical volume.

In another aspect combinable with any other aspect, a length of the first portion is less than a length of the second portion.

In another aspect combinable with any other aspect, the second portion of the passage has a frustoconical volume.

In another aspect combinable with any other aspect, the frustoconical volume of the passage is proximal to the passage outlet.

In another aspect combinable with any other aspect, the passage tapers from the passage inlet to the passage outlet.

In another aspect combinable with any other aspect, the passage tapers linearly from the passage inlet to the passage outlet.

In another aspect combinable with any other aspect, the passage tapers from the passage inlet to the passage outlet at an angle of between 0.5 degree and 20 degrees toward a central axis of the passage.

In another aspect combinable with any other aspect, the passage tapers from the passage inlet to the passage outlet at an angle of substantially 9.6 degrees toward a central axis of the passage.

In another aspect combinable with any other aspect, the passage tapers exponentially from the passage inlet to the passage outlet.

In another aspect combinable with any other aspect, the passage tapers in a serpentine shape from the passage inlet to the passage outlet.

In another aspect combinable with any other aspect, the passage inlet has at least one of a circular cross-section, an oval cross-section, or a rounded rectangle cross-section.

In another aspect combinable with any other aspect, the passage outlet includes at least one of a circular cross-section, an oval cross-section, or a rounded rectangle cross-section.

In another aspect combinable with any other aspect, a central axis of the exhaust port is substantially orthogonal to a plane defined by the passage outlet.

In another aspect combinable with any other aspect, a central axis of the exhaust port is substantially orthogonal to a top surface of the valve manifold.

In another aspect combinable with any other aspect, the passage outlet is positioned on a top surface of the valve manifold.

In another aspect combinable with any other aspect, the exhaust port connects the manifold interior to an atmosphere.

In another aspect combinable with any other aspect, the bed system includes a housing surrounding the pump and the valve manifold. The atmosphere is within the housing.

In another aspect combinable with any other aspect, the exhaust port increases a velocity of fluid flowing from the passage inlet to the passage outlet.

In another aspect combinable with any other aspect, the exhaust port increases the velocity of fluid flowing from the passage inlet to the passage outlet between 0.5 and 0.75 times.

In another aspect combinable with any other aspect, the exhaust port, responsive to increasing the velocity of the fluid flowing from the passage inlet to the passage outlet, reduce a sound level of the fluid.

In another aspect combinable with any other aspect, the sound level is reduced between 0.25 and 0.75 times.

In another aspect combinable with any other aspect, the sound level is reduced to at least 7 dB.

In another aspect combinable with any other aspect, the bed system includes an exhaust valve having a valve disc to selectively open and close the exhaust port by contacting the passage inlet of the exhaust port.

In another aspect combinable with any other aspect, the bed system includes an outlet valve positioned in the manifold interior. The outlet valve selectively regulates fluid communication between the pump and the inflatable chamber.

In another aspect combinable with any other aspect, the bed system includes a hose connecting the pump to the inlet port of the valve manifold.

In another aspect combinable with any other aspect, the bed system includes a hose connecting the outlet port to the at least one inflatable chamber.

In another aspect, a valve manifold has a manifold, an inlet port, an outlet port, and an exhaust port. The manifold housing defines a manifold interior. The inlet port passes through the manifold housing. The inlet port conduct fluid to the manifold interior. The outlet port passes through the manifold housing. The outlet port conducts fluid to and from the manifold interior. The exhaust port passes through the manifold housing. The exhaust port has a means for increasing a velocity of fluid flowing through the exhaust port.

In yet another aspect, a valve manifold has a manifold, an inlet port, an outlet port, and an exhaust port. The manifold housing defines a manifold interior. The inlet port passes through the manifold housing. The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. The passage outlet is smaller than the passage inlet.

In another aspect, a bed system has a valve manifold and a mattress. The valve manifold has a manifold housing, an inlet port, an outlet port, and an exhaust port. The manifold housing defines a manifold interior. The inlet port passes through the manifold housing. The inlet port conducts fluid from a pump to the manifold interior. The outlet port passes through the manifold housing. The outlet port conducts fluid to and from the manifold interior. The exhaust port passes through the manifold housing. The exhaust port defines a passage having a passage inlet and a passage outlet. The passage outlet is smaller than the passage inlet. The mattress has a fluid bladder. The fluid bladder is coupled to the outlet port.

In another aspect, a pump system has a valve manifold and a pump. The valve manifold has a manifold housing, an inlet port, an outlet port, and an exhaust port. The manifold housing defines a manifold interior. The inlet port passes through the manifold housing. The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. The passage outlet is smaller than the passage inlet. The pump is fluidly connected to the inlet port.

In another aspect, a valve manifold has a manifold housing, an inlet port, an outlet port, and an exhaust port. The manifold housing defines a manifold interior. The inlet port passes through the manifold housing. The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. At least a portion of the passage is frustoconical between the passage inlet and the passage outlet.

In another aspect, valve manifold has a manifold housing, an inlet port, an outlet port, and an exhaust port. The manifold housing defines a manifold interior. The inlet port passes through the manifold housing. The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. The first portion of the passage is frustoconical and a second portion of the passage is not frustoconical.

In another aspect, a valve manifold has a manifold housing, an inlet port, an outlet port, and an exhaust port. The manifold housing defines a manifold interior. The inlet port passes through the manifold housing. The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. The passage is cylindrical proximate the passage inlet and frustoconical proximate the passage outlet.

In another aspect, a valve manifold includes a manifold housing, an inlet port, an outlet port, and an exhaust port. The manifold housing defines a manifold interior. The inlet port passes through the manifold housing . . . The inlet port conducts fluid to the manifold interior. The outlet port passes through the manifold housing. The outlet port conducts fluid to and from the manifold interior. The exhaust port passes through the manifold housing. The exhaust port defines a passage having a passage inlet and a passage outlet. The passage tapers from the passage inlet to the passage outlet.

In another aspect, a pump system for a bed system has a fluid pump and a valve manifold. The valve manifold includes any aspects of any of the previous claims.

In yet another aspect, a pillow has at least one inflatable chamber, a pump, and a valve manifold. The valve manifold has a manifold housing, an inlet port, an outlet port, and an exhaust port. The manifold housing defines a manifold interior. The inlet port passes through the manifold housing. The inlet port conducts fluid from the pump to the manifold interior. The outlet port passes through the manifold housing. The outlet port conducts fluid from the manifold interior to and from the at least one inflatable chamber. The exhaust port passes through the manifold housing. The exhaust port defines a passage having a passage inlet and a passage outlet. The passage outlet is smaller than the passage inlet.

In another aspect, a bed system includes a pillow and a controller. The pillow has at least one inflatable chamber. The controller regulates fluid flow to and from the at least one inflatable chamber. The controller includes a pump and a valve manifold. The pump flows fluid to the at least one inflatable chamber. The valve manifold is fluidly coupled between the pump and the at least one inflatable chamber. The valve manifold has a manifold housing, an inlet port, an outlet port, and an exhaust port. The manifold housing defines a manifold interior. The inlet port passes through the manifold housing. The inlet port conducts fluid from the pump to the manifold interior. The outlet port passes through the manifold housing. The outlet port conducts fluid from the manifold interior to and from the at least one inflatable chamber. The exhaust port passes through the manifold housing. The exhaust port defines a passage having a passage inlet and a passage outlet. The passage outlet is smaller than the passage inlet.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an example bed system.

FIG. 2 is a block diagram of an example of various components of a bed system.

FIG. 3 is a perspective view of a controller for use in a bed system.

FIG. 4 is a perspective view of the controller of FIG. 3 with a top of a housing removed.

FIG. 5 is a top view of the controller of FIG. 3 with the top of the housing removed.

FIG. 6 is a side view of the controller of FIG. 3 with the top of the housing removed.

FIG. 7 is a bottom sectional view of the manifold and valves taken along line 7-7 of FIG. 6.

FIG. 8 is a bottom sectional view of the manifold and valves with plungers removed.

FIG. 9 is a perspective exploded view of the manifold and valves.

FIG. 10 is a perspective view of another example controller for use in the bed system of FIG. 1.

FIG. 11 is top view of a valve manifold of the controller of FIG. 10.

FIG. 12 is a bottom view of the valve manifold of FIG. 11.

FIG. 13 is cross section view of the valve manifold of FIG. 11.

### DETAILED DESCRIPTION

A controller, such as for inflatable beds, can have a pump, a manifold, and one or more valves. Such a manifold can include one or more passages, such as an exhaust port, with a shape that is configured to reduce noise generated by a fluid such as air flowing though the exhaust port. This can be particularly desirable in inflatable beds where noise can be undesirable, especially during sleep of a user. The beds can be inflated by a fluid. For example, the fluid can be air or water, however, any suitable fluid can be used.

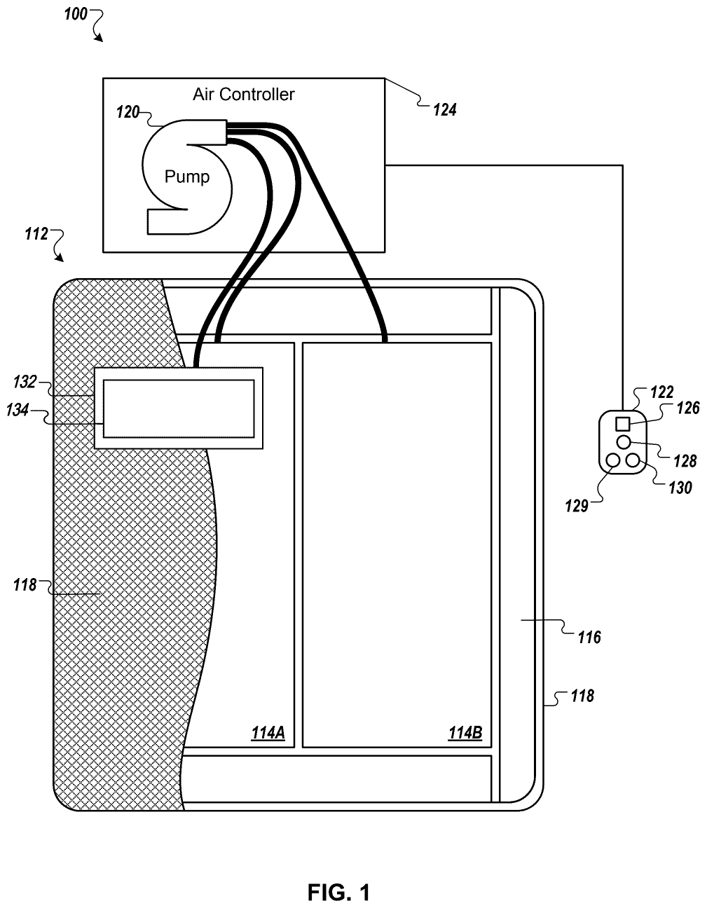

FIG. 1 shows an example bed system 100 that includes a bed 112. The bed 112 includes at least one inflatable chamber 114 surrounded by a resilient border 116 and encapsulated by bed ticking 118. The resilient border 116 can comprise any suitable material, such as foam.

As illustrated in FIG. 1, the bed 112 can be a two chamber design having first and second fluid chambers, such as a first inflatable chamber 114A and a second inflatable chamber 114B. In alternative embodiments, the bed 112 can include chambers for use with fluids other than air that are suitable for the application. In some embodiments, such as single beds or kids' beds, the bed 112 can include a single inflatable chamber 114A or 114B or multiple inflatable chambers 114A and 114B. The first and second inflatable chambers 114A and 114B can be in fluid communication with a pump 120. The pump 120 can be part of a controller 124, which can be in electrical communication with a remote control 122. The controller 124 can include a wired or wireless communications interface for communicating with one or more devices, including the remote control 122. The controller 124 can be configured to operate the pump 120 to cause increases and decreases in the fluid pressure of the first and second inflatable chambers 114A and 114B based upon commands input by a user using the remote control 122. In some implementations, the pump 120 and the controller 124 can be integrated into a common housing. In other embodiments, the controller 124 and the pump 120 can be in separate housings.

The remote control 122 can include a display 126, an output selecting mechanism 128, a pressure increase button 129, and a pressure decrease button 130. The output selecting mechanism 128 can allow the user to switch fluid flow generated by the pump 120 between the first and second inflatable chambers 114A and 114B, thus enabling control of multiple inflatable chambers with a single remote control 122 and a single pump 120. For example, the output selecting mechanism 128 can by a physical control (e.g., switch or button) or an input control displayed on display 126. Alternatively, separate remote control units can be provided for each inflatable chamber and can each include the ability to control multiple inflatable chambers. Pressure increase and decrease buttons 129 and 130 can allow a user to increase or decrease the pressure, respectively, in the inflatable chamber selected with the output selecting mechanism 128. Adjusting the pressure within the selected inflatable chamber can cause a corresponding adjustment to the firmness of the respective inflatable chamber. In some embodiments, the remote control 122 can be omitted or modified as appropriate for an application. For example, in some embodiments the bed 112 can be controlled by a computer, tablet, smart phone, or other device in wired or wireless communication with the bed 112.

The example inflatable bed system 100 can include one or more pillows 132. Each pillow 132 can include one or more inflatable chambers 134. The inflatable chambers 134 of the pillows 132 can be fluidly coupled to the controller 124. The controller 124 can cause an increase or decrease in the fluid pressure in one or more of the inflatable chambers 134.

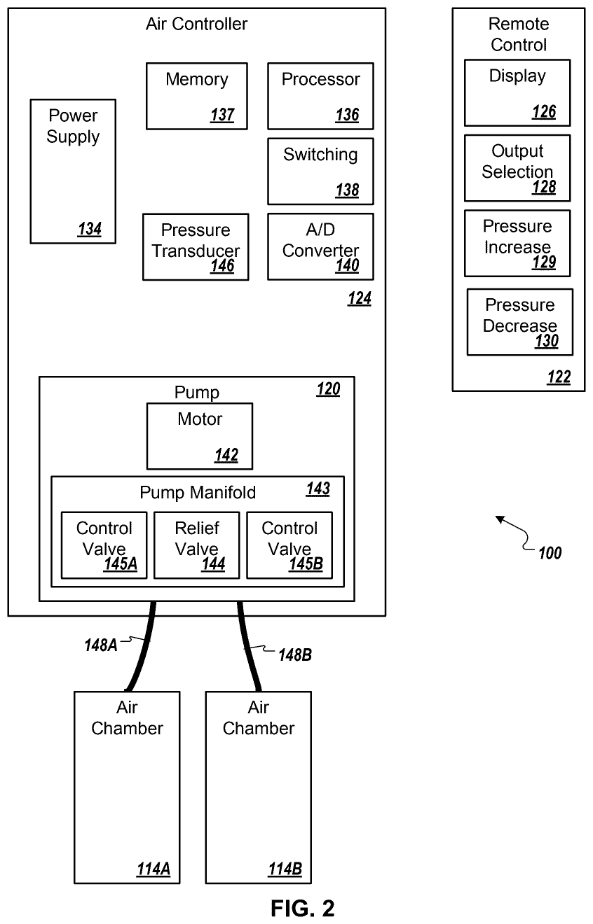

FIG. 2 is a block diagram of an example of various components of an inflatable bed system. For example, these components can be used in the example inflatable bed system 100. As shown in FIG. 2, the controller 124 can include the pump 120, a power supply 134, a processor 136, a memory 137, a switching mechanism 138, and an analog to digital (A/D) converter 140, a fluid manifold 143 (having valves 144, 145A, and 145B), and one or more pressure transducers 146. The switching mechanism 138 can be, for example, a relay or a solid state switch.

The pump 120 can include a motor 142. The pump 120 can be fluidly connected to the pump manifold 143, which is fluidically connected with the first inflatable chamber 114A and the second inflatable chamber 114B via a first tube 148A and a second tube 148B, respectively. The first and second control valves 145A and 145B can be controlled by the switching mechanism 138, and they are operable to regulate the flow of fluid between the pump 120 and first and second inflatable chambers 114A and 114B, respectively.

In some implementations, the pump 120 can be fluidly connected to the pillow 132 by the pump manifold 143. For example, the pump manifold 143 can include additional control valves, substantially similar to control valves 145A and 145B to regulate the flow of fluid between the pump 120 and the inflatable chamber 134 of the pillow 132. Alternatively or in addition, the controller 124 can include another pump manifold 143 fluidly connected between the pump 120 and the pillow 132 to regulate the flow of fluid between the pump 120 and the inflatable chamber 134 of the pillow 132.

In some implementations, the pump 120 and the controller 124 can be provided and packaged as a single unit. In some alternative implementations, the pump 120 and the controller 124 can be provided as physically separate units. In some implementations, the controller 124, the pump 120, or both are integrated within or otherwise contained within a bed frame or bed support structure that supports the bed 112. In some implementations, the controller 124, the pump 120, or both are located outside of a bed frame or bed support structure (as shown in the example in FIG. 1).

The example inflatable bed system 100 depicted in FIG. 2 includes the two inflatable chambers 114A and 114B and the single pump 120. However, other implementations can include an inflatable bed system having two or more inflatable chambers and one or more pumps incorporated into the inflatable bed system to control the inflatable chambers. For example, a separate pump can be associated with each inflatable chamber of the inflatable bed system or a pump can be associated with multiple chambers of the inflatable bed system. Separate pumps can allow each inflatable chamber to be inflated or deflated independently and simultaneously. Furthermore, additional pressure transducers can also be incorporated into the inflatable bed system such that, for example, a separate pressure transducer can be associated with each inflatable chamber.

In use, the processor 136 can, for example, send a decrease pressure command for one of the inflatable chambers 114A or 114B, and the switching mechanism 138 can be used to convert the low voltage command signals sent by the processor 136 to higher operating voltages sufficient to operate the relief valve 144 of the pump 120 and open the control valve 145A or 145B. Opening the relief valve 144 can allow fluid to escape from the inflatable chamber 114A or 114B through the respective tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 in order to convey the pressure information to the user.

As another example, the processor 136 can send an increase pressure command. The pump motor 142 can be energized in response to the increase pressure command and send fluid to one of the designated inflatable chambers 114A or 114B through the fluid tube 148A or 148B via electronically operating the corresponding valve 145A or 145B. While fluid is being delivered to the designated inflatable chamber 114A or 114B in order to increase the firmness of the chamber, the pressure transducer 146 can sense pressure within the manifold 143. Again, the pressure transducer 146 can send pressure readings to the processor 136 via the A/D converter 140. The processor 136 can use the information received from the A/D converter 140 to determine the difference between the actual pressure in inflatable chamber 114A or 114B and the desired pressure. The processor 136 can send the digital signal to the remote control 122 to update display 126 in order to convey the pressure information to the user.

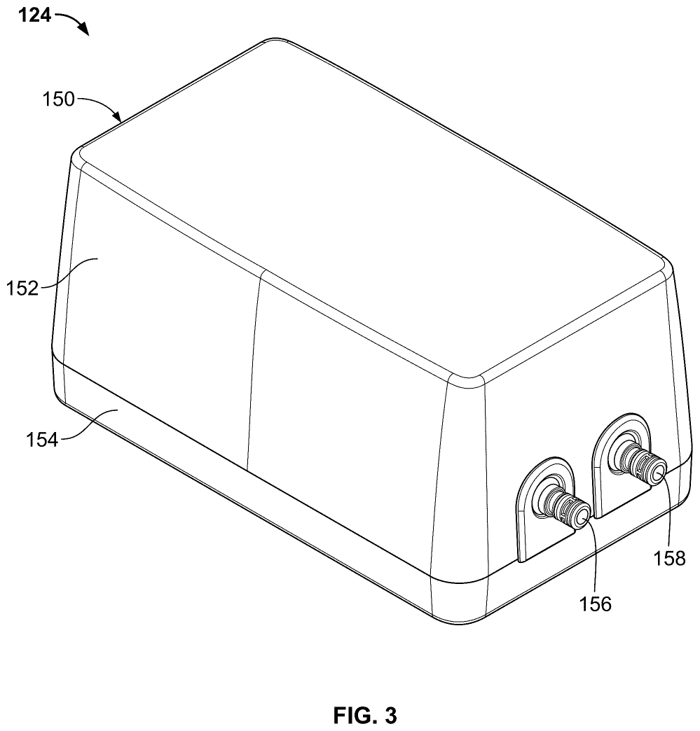

FIG. 3 is a perspective view of the controller 124 in a housing 150. The housing 150 can include a housing top 152 and a housing bottom 154 and can substantially enclose components of the controller 124. One or more nozzles 156 and 158 (also referred to as outlets) can extend through the housing 150 and can be detachably connected to the fluid tubes 148A and 148B (shown in FIG. 2) for inflating the fluid chambers 114A and 114B (shown in FIG. 2).

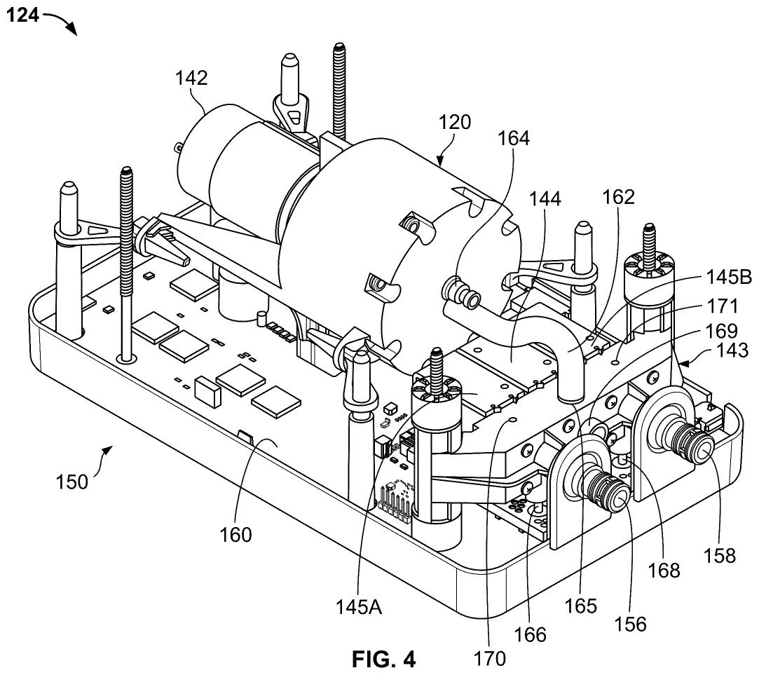

FIG. 4 is a perspective view of the controller 124 with the housing top 152 (shown in FIG. 3) removed so as to show internal components. As shown in FIG. 4, the housing 150 of the controller 124 contains the pump 120 and its motor 142, the manifold 143, and a printed circuit board 160 (which can include some or all of the power supply 134, the processor 136, the memory 137, the switching mechanism 138, the A/D converter 140, and the pressure transducer 146 shown in FIG. 2).

A tube 162 can extend from a nozzle 164 of the pump 120 to the manifold 143 for fluidly connecting the pump 120 to the manifold 143. One or more additional tubes 166 and 168 can extend from the manifold 143 to one or more pressure transducers 146 (shown in FIG. 2) on the printed circuit board 160.

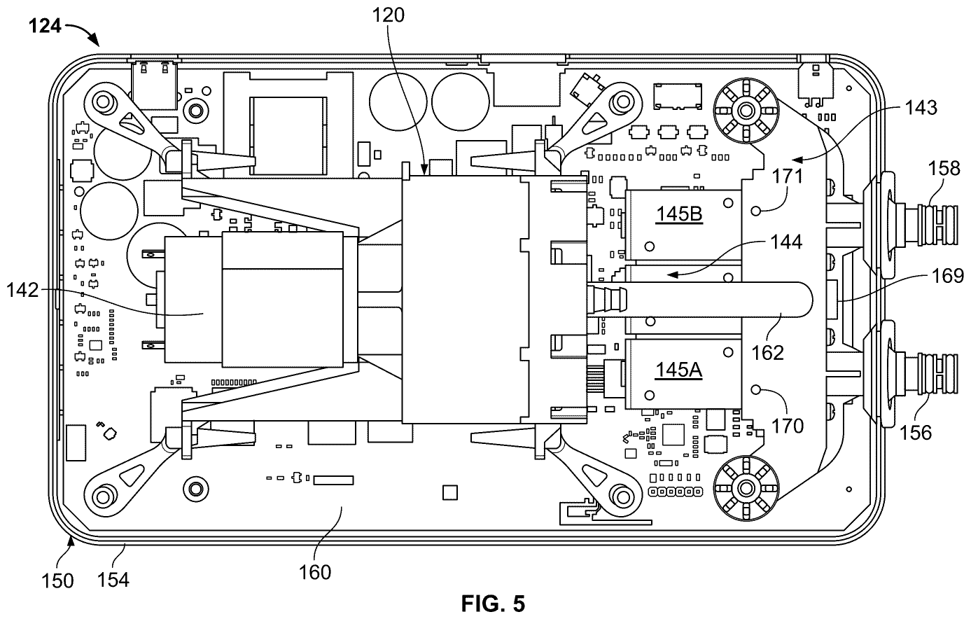

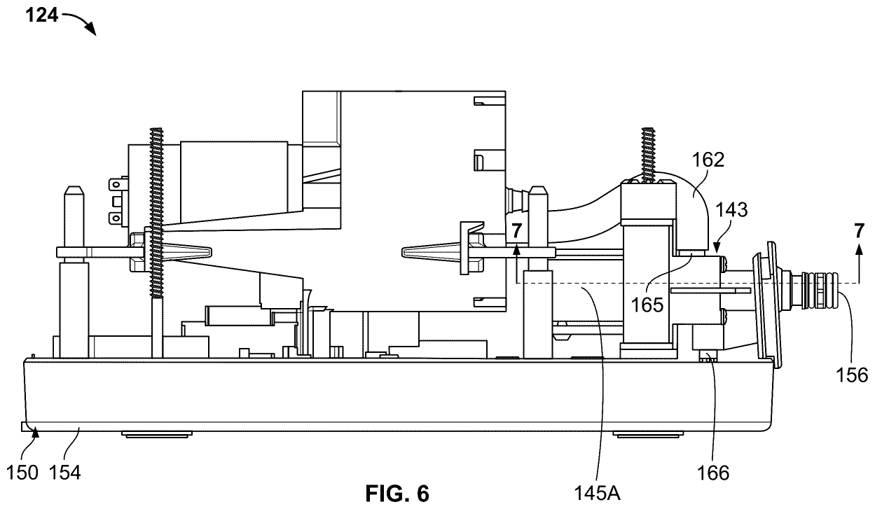

FIG. 5 is a top view of the controller 124 with the housing top 152 removed. FIG. 6 is a side view of the controller 124 with the housing top 152 removed.

As shown in FIGS. 4-6, the manifold 143 includes the valves 144, 145A, and 145B attached thereto. The valve 145A can be controlled to selectively open and close to allow and restrict flow through the nozzle 156 to the inflatable chamber 114A (shown in FIGS. 1 and 2). The valve 145B can be controlled to selectively open and close to allow and restrict flow through the nozzle 158 to the inflatable chamber 114B (shown in FIGS. 1 and 2). The valve 144 can be controlled to selectively open and close to allow and restrict flow through an outlet port 170, allowing one of the inflatable chambers 114A and 114B to be deflated when one of their respective valves 145A and 145B is open at the same time as the valve 144. Accordingly, the inflatable manifold 143 can selectively allow fluid flow between the pump 120 (via the tube 162), the inflatable chamber 114A (via the nozzle 156), the inflatable chamber 114B (via the nozzle 158), and the atmosphere (via the outlet port 170) depending on the open and closed status of the valves 144, 145A, and 145B.

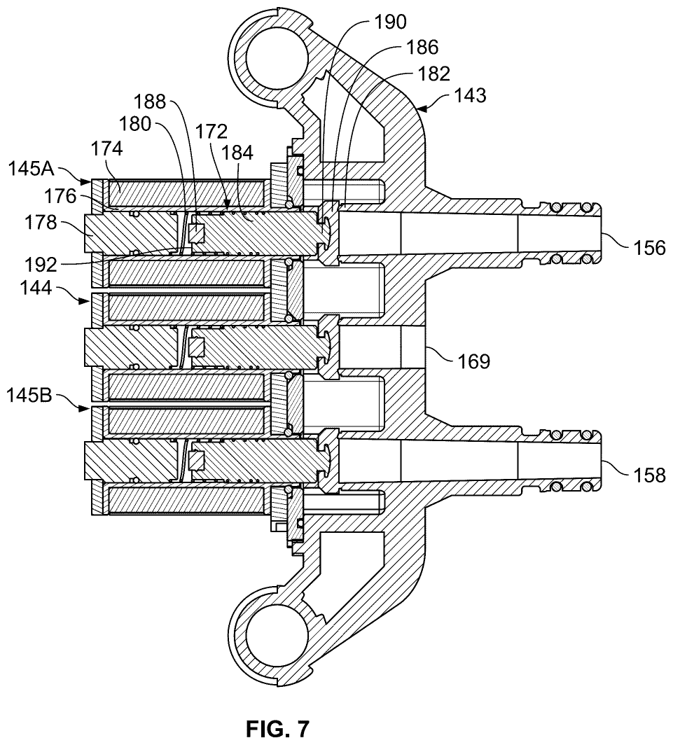

FIG. 7 is a bottom sectional view of the manifold 143 along with the valves 144, 145A, and 145B. In the embodiment shown in FIG. 7, the valves 144, 145A, and 145B are solenoid valves each with a plunger 172. In some embodiments, the valves 144, 145A, and 145B can include some or all of the same or similar components. For example, the valve 145A can include the plunger 172, a solenoid coil 174, a core tube 176, a seal insert 178 (also called a seal column or a plug nut in some cases), a core spring 180, and a valve seat 182. The plunger 172 can include a core 184, a valve disc 186 (also called a valve member or a valve seal in some cases), and a bumper 188. The valve disc 186 is attached to the core 184 at a head 190 of the core 184 and the bumper 188 is attached to the core 184 at a tail 192 of the core 184.

The core 184 can be a metal that responds to a magnetic field (such as iron, nickel, cobalt, certain steels, and certain alloys) and that moves when the solenoid coil 174 is energized. The core 184 is positioned in the core tube 176, which the solenoid coil 174 is wrapped around. The seal insert 178 seals the core tube 176 behind the core 184 and the core spring 180 is positioned between the seal insert 178 and the core 184 in compression.

FIG. 7 shows the valves 144, 145A, and 145B in the sealed position, in which the spring 180 presses against the plunger 172 to seal the valve disc 186 against the valve seat 182. When the solenoid coil 174 is energized, it creates a magnetic field that drives the core 184 in a direction toward the tail 192 until the bumper 188 contacts the seal insert 178, at which point the plunger 172 can remain at rest in an open position. In the open position, the valve disc 186 is spaced from the valve seat 182 allowing flow through the valve seat 182 and the nozzle 156. When the solenoid coil 174 is de-energized, the compressed core spring 180 forces the plunger 172 back in the direction toward the head 190 to seal the valve seat 182 with the valve disc 186.

In some embodiments, the bumper 188 can be formed of a resilient polymer material configured to soften impact between the plunger 172 and the seal insert 178 when the valve 145A is opened. In some embodiments, the bumper 188 can be formed of hydrogenated nitrile butadiene rubber (“HNBR”), which can reliably soften impact and resist degradation under operation in the valve 145A. In other embodiments, the bumper 188 can be formed of another nitrile butadiene rubber (“NBR”) suitable to reliably soften impact and resist degradation under operation in the valve 145A. In other embodiments, the bumper 188 can be formed of a silicone or an EDPM rubber (ethylene propylene diene monomer (M-class) rubber) having a durometer suitable effectively seal, resist wear, and reduce noise during operation of the valve 145A. In some embodiments, the bumper 188 may be constructed from any suitable material or any combination of one or more such materials.

In some embodiments, the valve disc 186 can be formed of a resilient polymer material configured to seal the valve seat 182 and also to soften impact between the plunger 172 and the valve seat 182 when the valve 145A is closed. In some embodiments, the valve disc 186 can be formed of a polymer material that is different than that of the bumper 188. This can be beneficial because the valve disc 186 and the bumper 188 have different applications that benefit from different material properties. For example, the valve disc 186 can be formed of a silicone material, which is suitable for both valve sealing and for softening impact to dampen noise. In other embodiments, the valve disc 186 can be formed of another polymer material suitable for the application as a valve disc 186 in the valve 145A. In some embodiments, the valve disc 186 may be constructed from any suitable material or any combination of one or more such materials.

As shown in FIG. 7, the valve disc 186 of the plunger 172 can have a diameter larger than that of the valve seat 182, while the head 190 of the core 184 has a diameter less than that of the valve seat 182. Accordingly, when the plunger 172 closes with the core spring 180 forcing the core 184 toward the valve seat 182, the head 190 can tend to push further into the valve seat 182. Because the valve disc 186 is larger than the valve seat 182 and head 190 of the core 184 is smaller than the valve seat 182, the valve disc 186 can tend to bulge when the valve 145A is closed, with a center of the valve disc 186 pushing into the valve seat 182. This bulging action can further dampen the impact between the plunger 172 and the valve seat 182, as the bulging action can slow and ultimately stop movement of the core 184 more slowly than if the plunger 172 had no bulging action when the valve 145A is closed.

In some embodiments, a circumferential edge of the valve seat 182 can be radiused so as to contact the valve disc 186 with a rounded surface. For example, in some embodiments the edge of the valve seat 182 can have a radius of about 0.100 millimeter. In other embodiments, the edge of the valve seat 182 can have a radius of between 0.080 and 0.120 millimeter. In still other embodiments, the edge of the valve seat 182 can have a radius of between 0.030 and 0.200 millimeters.

In embodiments in which the valve disc 186 bulges into the hole defined by the valve seat 182, a radiused edge of the valve seat 182 can have an improved contact surface against the valve disc 186.

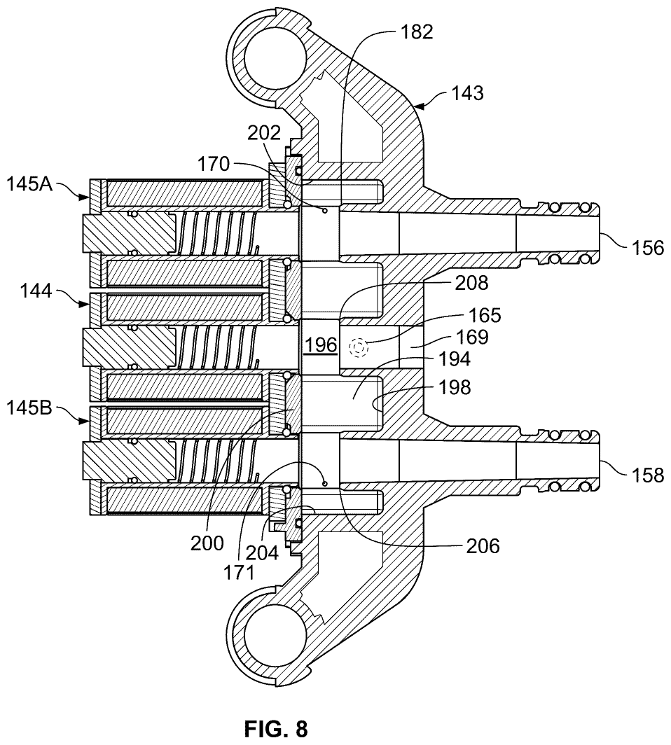

FIG. 8 is a bottom sectional view of the manifold 143 along with the valves 144, 145A, and 145B with the same view as in FIG. 7, but with the plungers 172 (shown in FIG. 7) removed. With the plungers 172 removed, the vents 170 and 171 can be better viewed. The manifold 143 defines a manifold interior 194 bounded by a manifold top 196, a manifold front 198, a manifold bottom (not shown in FIG. 8), a manifold back 200, and manifold sides 202 and 204. In the illustrated embodiment, the manifold back 200 is a manifold cover that connects to the rest of the manifold 143 and is positioned between the valves 144, 145A, and 145B and the rest of the manifold 143.

As shown in FIG. 8, the valve seat 182 is shown extending from the manifold front 198 into the manifold interior 194. A valve seat 206 corresponding to the valve 145B and a valve seat 208 corresponding to the valve 144 also extend from the manifold front 198 into the manifold interior 194. The valve seats 182, 206, and 208 can be positioned to allow for contact with their respective valve discs 186 (shown in FIG. 7) and to be spaced from the manifold top 196, the manifold side 202, the manifold side 204, and/or the manifold bottom to allow for fluid flow through the manifold interior 194. For example, the inlet 165 is shown in phantom behind the valve seat 208. The inlet 165 extends through the manifold top 196 to allow the pump 120 to supply fluid into the manifold interior 194. While the valve seat 208 is positioned below the inlet 165 (which is shown in the orientation of FIG. 8 as positioned above the inlet 165), the valve seat 208 does not prevent the flow of fluid through the inlet 165.

The terms front, back, top, bottom, side, above, and below are used for reference and illustration purposes, and it should be understood that the manifold 143 can be inverted or turned to a different orientation. Moreover, the specific shape of the manifold 143 is one example of a suitable manifold but it should be understood that the shape may be varied as suitable for the application.

As shown in FIG. 8, the manifold interior 194 can have a number of inlet and outlet openings. For example, the outlet 156, the outlet 158, the inlet 165, the exhaust port 169, the vent 170, and the vent 171 can all be fluidly connected via the manifold interior 194. Flow throughout the manifold interior 194 can be substantially unimpeded and flow into and out of the manifold interior 194 can be substantially unimpeded except via the operation of the valves 144, 145A, and 145B.

For example, when the valves 144, 145A, and 145B are all closed, the inlet 165, the vent 170, and the vent 171 can all be in fluid communication while the outlet 156, the outlet 158, and the exhaust port 169 can be substantially sealed by the valves 145A, 145B, and 144, respectively. Such a valve configuration can be suitable, for example, when the inflatable chambers 114A and 114B are at suitable pressures, and no inflation or deflation is desired.

When the valve 145A is open and the valve 144 and the valve 145B are closed, the inlet 165, the outlet 156, the vent 170, and the vent 171 can be in fluid communication. Such a valve configuration can be suitable, for example, to inflate the inflatable chamber 114A. The pump 120 can be operated to supply fluid through the inlet 165 into the manifold interior 194 and out the outlet 156 to the inflatable chamber 114A to inflate the inflatable chamber 114A. In embodiments in which the vents 170 and 171 are non-valved, fluid can also bleed out of the vents 170 and 171 when the pump 120 inflates the inflatable chamber 114A. The vents 170 and 171 can be sized to be small enough in comparison to the outlet defined by the outlet 156 such that the fluid loss through the vents 170 and 171 is negligible, or at least does not negatively affect the inflation operation in a substantial amount. This valve configuration can also be suitable, for example to slowly deflate the inflatable chamber 114A. When the pump 120 is not operated, fluid from the inflatable chamber 114A can flow through the outlet 156 into the manifold interior 194 and slowly out the vents 170 and 171. This can allow for slow deflation of the inflatable chamber 114A without requiring the valve 144 to be actuated to open the exhaust port 169.

When the valve 145B is open and the valve 144 and the valve 145A are closed, the inlet 165, the outlet 158, the vent 170, and the vent 171 can be in fluid communication. Such a valve configuration can be suitable, for example, to inflate the inflatable chamber 114B. The pump 120 can be operated to supply fluid through the inlet 165 into the manifold interior 194 and out the outlet 158 to the inflatable chamber 114B to inflate the inflatable chamber 114B. Fluid can also bleed out of the vents 170 and 171 when the pump 120 inflates the inflatable chamber 114B, yet the fluid loss through the vents 170 and 171 need not negatively affect the inflation operation in a substantial amount due to the relatively small size of the vents 170 and 171. This valve configuration can also be suitable, for example to slowly deflate the inflatable chamber 114B. When the pump 120 is not operated, fluid from the inflatable chamber 114B can flow through the outlet 158 into the manifold interior 194 and slowly out the vents 170 and 171. This can allow for slow deflation of the inflatable chamber 114B without requiring the valve 144 to be actuated to open the exhaust port 169.

When the valve 145A and the valve 144 are open and the valve 145B is closed, the inlet 165, the outlet 156, the exhaust port 169, the vent 170, and the vent 171 can be in fluid communication. Such a valve configuration can be suitable, for example, to quickly deflate the inflatable chamber 114A. When the pump 120 is not operated, fluid from the inflatable chamber 114A can flow through the outlet 156 into the manifold interior 194 and out the vents 170 and 171 as well as the open exhaust port 169. This can allow for quicker deflation of the inflatable chamber 114A.

When the valve 145B and the valve 144 are open and the valve 145A is closed, the inlet 165, the outlet 158, the exhaust port 169, the vent 170, and the vent 171 can be in fluid communication. Such a valve configuration can be suitable, for example, to quickly deflate the inflatable chamber 114B. When the pump 120 is not operated, fluid from the inflatable chamber 114B can flow through the outlet 158 into the manifold interior 194 and out the vents 170 and 171 as well as the open exhaust port 169. This can allow for quicker deflation of the inflatable chamber 114B.

Deflation using the vents 170 and 171 as well as the exhaust port 169 can allow for deflation of one or both of the inflatable chambers 114A and 114B relatively quickly. This can be desirable when deflation is performed in response to a user input, such as a command for a softer mattress. In some applications, the sound of the fluid rushing out of the exhaust port 169 can be noticeably audible. In addition, actuation of the valve 144 can also be noticeably audible. Such sound can be of little concern when the user is awake, such as when the user is issuing a command for deflation. However, such sound can be undesirable while a user is asleep, such as if the controller 124 is making automatic adjustment to fluid pressure.

Deflation using the vents 170 and 171 while the exhaust port 169 is closed by the valve 144 can be relatively slow and quiet. Such deflation can be desirable for making automatic pressure adjustments while a user is sleeping, a time where noise is undesirable. While slow deflation may be undesirable when a user issues a command expecting immediate results, slow deflation can be desirable when the controller 124 seeks to change fluid pressure in one of the inflatable chambers 114A and 114B without the user noticing.

Accordingly, the exhaust port 169 can be relatively large as compared to the vents 170 and 171 to allow for the ability to deflate at two different speeds. For example, in some embodiments, the exhaust port 169 can have a diameter of about 5/16 inch and the vents 170 and 171 can have a diameter of about 15/1000 inch. In such embodiments, the exhaust port 169 can have a diameter that is about 20 times larger than the diameter of each of the vents 170 and 171 and can have an area that is about 400 times larger than the area of each of the vents 170 and 171 (or about 200 times larger than the combined area of the vents 170 and 171).

In some embodiments, the diameter of the vents 170 and 171 can be between 0.005 inch and 0.04 inch. In some of such embodiments, the diameter of the exhaust port 169 can be between about 0.2 inch and about 0.6 inch. In such embodiments, the exhaust port 169 can have a diameter that is between 5 and 120 times larger than the diameter of each of the vents 170 and 171 and can have an area that is between 25 and 14,400 times larger than the area of each of the vents 170 and 171 (or between 12.5 and 7,200 times larger than the combined area of the vents 170 and 171). However, in other embodiments the dimensions of the exhaust port 169 can be any suitable dimension.

In the illustrated embodiment, the vents 170 and 171 are substantially cylindrical holes, such as pin holes formed in an injection molding process. In other embodiments, the vents 170 and 171 can have another shape or configuration suitable for the application of slowly venting fluid during a deflation operation.

In some embodiments in which the pump 120 is a positive displacement pump, the pump 120 can allow little or no back flow. Accordingly, little or no fluid deflated from the inflatable chambers 114A and 114B can flow through the pump 120 during deflation and instead must flow elsewhere, such as through the vents 170 and 171 and/or the exhaust port 169.

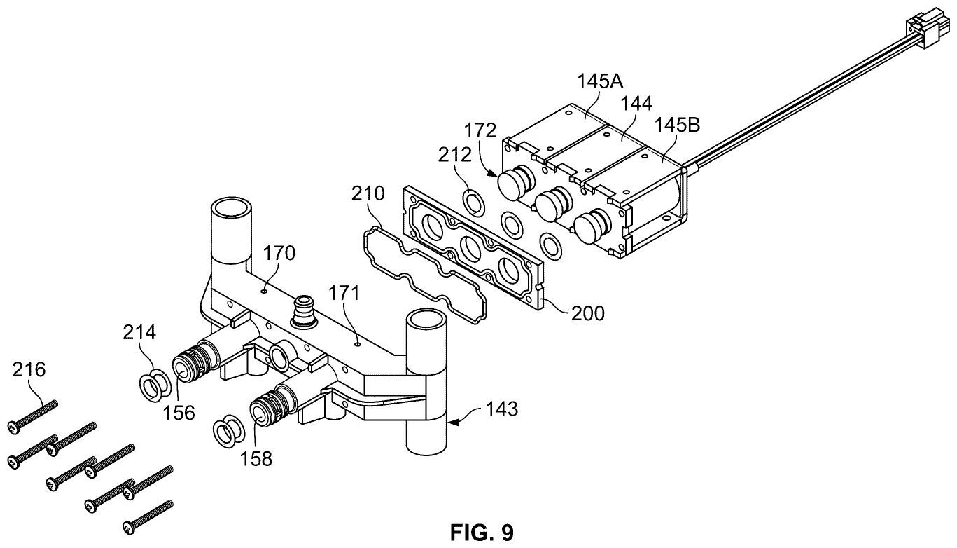

FIG. 9 is a perspective exploded view of the manifold 143 and the valves 144, 145A, and 145B. FIG. 9 shows a gasket 210 positioned between the manifold back 200 (or manifold cover) and the rest of the manifold 143, O-rings 212 between the manifold back 200 and the valves 144, 145A, and 145B, and O-rings 214 on the outlets 156 and 158. The gasket 210 and the O-rings 212 and 214 can substantially seal the manifold 143 when assembled, except through designated openings such as the vents 170 and 171. One or more bolts 216 or other fasteners can connect the manifold 143 to the valves 144, 145A, and 145B.

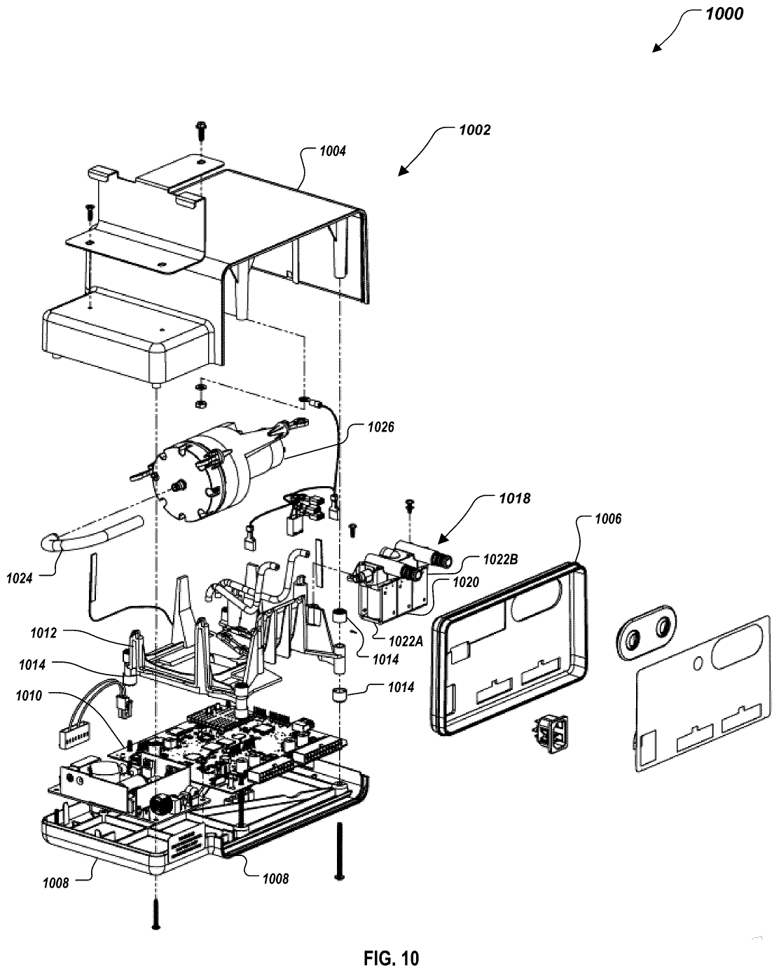

FIG. 10 is a perspective view of another example controller 1000 for use in the bed system 100 of FIG. 1. The controller 1000 is operable to cause increases and decreases in the fluid pressure of the first and second inflatable chambers 114A and 114B either automatically or based upon commands input by the user using the remote control 122 as previously described in reference to FIGS. 1-9.

The controller 1000 has a housing 1002 enclosing various components of the controller 1000. The housing 1002 is a three piece enclosure which includes a housing top 1004, a housing side 1006, and a housing bottom 1008 coupled to the housing top 1004 and the housing side 1006. The housing top 1004 and housing bottom 1008 are fastened together to couple to the housing side 1006, enclosing the components of the controller 1000.

The controller 1000 has a printed circuit board 1010 mounted to the housing bottom 1008 and a carriage 1012 at least partially vibrationally isolated by vibration isolators 1014. The carriage 1012 is mounted between the printed circuit board 1010 and the housing top 1004.

The controller 1000 has a pump 1016 and a valve manifold 1018 coupled to the pump 1016. The pump 1016 pressurizes and flows fluid to the first and second inflatable chambers 114A and 114B. The valve manifold 1018 controls the flow of fluid from the pump 1016 to and from the first and second inflatable chambers 114A and 114B.

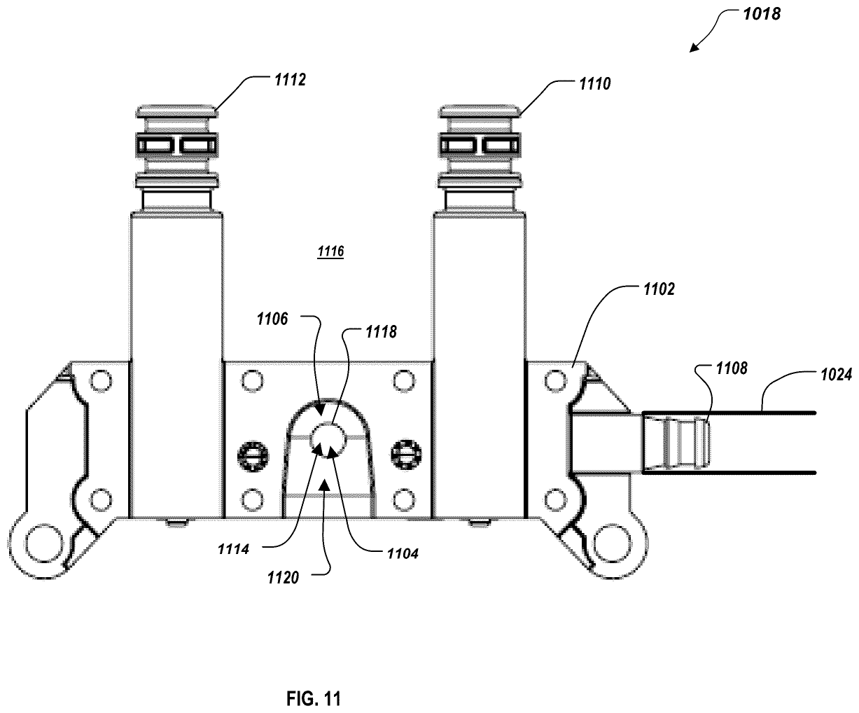

Referring to FIGS. 1, 2, and 10, the controller 1000 includes valves 1020 and 1022A, 1022B, generally similar to the valves 144, 145A, and 145B, respectively, described previously. The valves 1020 and 1022A, 1022B are attached to the valve manifold 1018. The valve 1022A can be controlled to selectively open and close to allow and restrict flow through valve manifold 1018 to the inflatable chamber 114A (shown in FIGS. 1 and 2). The valve 1022B can be controlled to selectively open and close to allow and restrict flow through the valve manifold 1018 to the inflatable chamber 114B (shown in FIGS. 1 and 2). The valve 1020 can be controlled to selectively open and close to allow and restrict flow through an exhaust port 1106 (described in more detail in reference to FIGS. 11-13), allowing one of the inflatable chambers 114A and 114B to be deflated when one of their respective valves 1022A and 1022B is open at the same time as the valve 1020. Accordingly, the valve manifold 1018 can selectively allow fluid flow between the pump 1026 (via tube 1024), the inflatable chamber 114A, the inflatable chamber 114B, and the atmosphere (via the exhaust port 1106) depending on the open and closed status of the valves 1020, 1022A, and 1022B. In some embodiments, the valve manifold 1018 can have more or fewer valves and/or inlets and outlets.

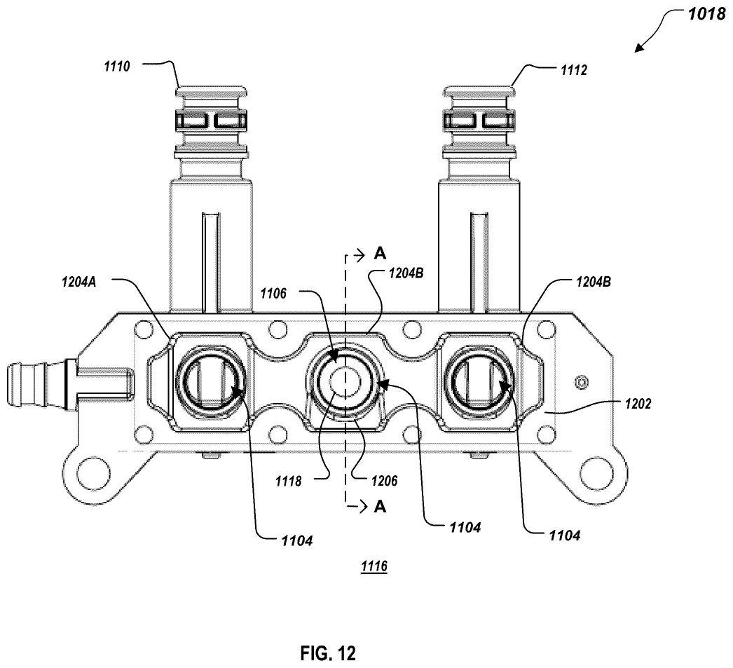

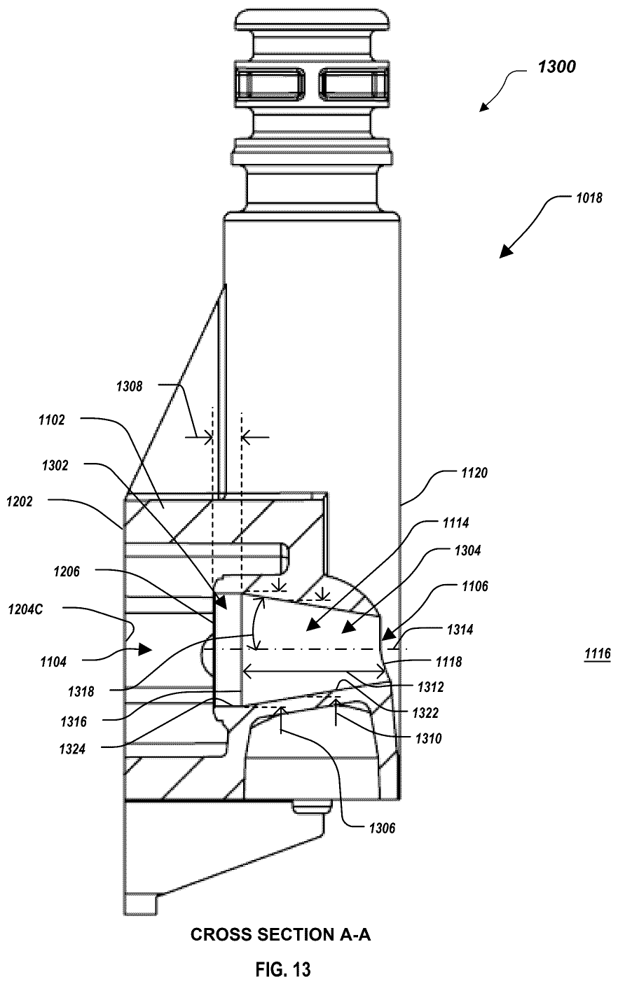

FIG. 11 is top view of the valve manifold 1018 of the controller 1000 of FIG. 10. FIG. 12 is a bottom view of the valve manifold 1018 of FIG. 11. FIG. 13 is cross section view of the valve manifold 1018 of FIG. 11. Referring to FIGS. 11-13, the valve manifold 1018 controls fluid flow, such as a fluid flow, to and from the first and second inflatable chambers 114A and 114B (shown in FIG. 1).

The valve manifold 1018 has a manifold housing 1102 defining a manifold interior 1104. The manifold housing 1102 is a body to conduct the flow of fluid to and from the first and second inflatable chambers 114A and 114B. The manifold interior 1104 is an inner volume of the valve manifold 1018.

The valve manifold 1018 has a valve manifold-pump nozzle 1108 extending from the manifold housing 1102 and fluidly coupled to the valve manifold interior 1104. The valve manifold-pump nozzle 1108 is an inlet port into the valve manifold 1018. The valve manifold-pump nozzle 1108 conducts fluid from the tube 1024 into the manifold interior 1104. The valve manifold-pump nozzle 1108 is coupled to the tube 1024.

The valve manifold 1018 has a valve manifold-first chamber nozzle 1110 and a valve manifold-second chamber nozzle 1112 extending from the manifold housing 1102 and fluidly coupled to the valve manifold interior 1104. The valve manifold-first chamber nozzle 1110 and the valve manifold-second chamber nozzle 1112 conduct fluid to and from the first and second inflatable chambers 114A and 114B. The valve manifold-first chamber nozzle 1110 and the valve manifold-second chamber nozzle 1112 are coupled to the tubes 148A and 148B (shown in FIG. 2) for inflating the inflatable chambers 114A and 114B (shown in FIG. 2). In some cases, the tubes 148A and 148B are detachably connected to the valve manifold-first chamber nozzle 1110 and the valve manifold-second chamber nozzle 1112. The valve 1022A can be controlled to selectively open and close to allow and restrict flow through the valve manifold-first chamber nozzle 1110 to the inflatable chamber 114A (shown in FIGS. 1 and 2). The valve 1022B can be controlled to selectively open and close to allow and restrict flow through the valve manifold-second chamber nozzle 1112 to the inflatable chamber 114B (shown in FIGS. 1 and 2). The valve manifold-first chamber nozzle 1110 and the valve manifold-second chamber nozzle 1112 are outlet ports from the valve manifold 1018.

Referring to FIGS. 12 and 13, the valve manifold 1018 has a valve-facing surface 1202. The valves 144, 145A, and 145B are coupled to the valve manifold 1018 on the valve-facing surface 1202. In this example implementation of the controller 1000, the valve-facing surface 1202 is oriented toward the housing bottom 1008 as shown in FIG. 10 (i.e., a downward vertical direction). The valves 1022A and 1022B are generally oriented perpendicular to the valve manifold-first chamber nozzle 1110 and the valve manifold-second chamber nozzle 1112. The valve 1020 is generally oriented linearly with the exhaust port 1106, with the exhaust port 1106 oriented in an upward vertical direction toward the housing top 1004.

In other implementations, the valve-facing surface 1202 can be oriented in any other suitable direction. For example, as shown in FIGS. 4-6, the valve-facing surface is generally oriented in a horizontal direction toward the pump 120 and the housing sides. The valves 145A and 145B are generally oriented linearly in the same plane as the nozzles 156 and 158. The valve 144 is likewise generally oriented linearly with the exhaust port 169, with the exhaust port 169 oriented in a horizontal plane away from the pump 120 and toward the housing side in the same general direction as the outlets 156 and 158.

Referring to FIGS. 12 and 13, the valve manifold 1018 has ports 1204A, 1204B, and 1204C on the valve-facing surface 1202. The port 1204A is coupled to the valve 1022A. The port 1204A is sized to allow the plunger of valve 1022A to pass through into the manifold interior 1104 and control liquid flow through the manifold interior 1104 to and from the valve manifold-first chamber nozzle 1110. The plunger of the controller 1000 is generally similar to the plungers 172 described in reference to FIGS. 7-8. The port 1204B is coupled to the valve 1022B. The port 1204B is sized to allow the plunger of valve 1022B to pass through into the manifold interior 1104 and control liquid flow through the manifold interior 1104 to and from the valve manifold-second chamber nozzle 1112. The port 1204C is coupled to the valve 1020. The port 1204C is sized to allow the plunger of valve 1020 to pass through into the manifold interior 1104 and control liquid flow through the manifold interior 1104 to and from the exhaust port 1106.

Referring to FIGS. 11-13, the exhaust port 1106 passes through the manifold housing 1102 and defines a passage 1114 from the manifold interior 1104 to a space 1116 outside the manifold housing 1102. The space 1116 can be the atmosphere within the housing 1002. The exhaust port 1106 increases the velocity of fluid (i.e., air, water, or any other suitable fluid) flowing out of the manifold interior 1104 through the exhaust port 1106 to atmosphere 1116. The exhaust port 1106 is positioned on a top surface 1120 of the manifold housing 1102.

The passage 1114 of the exhaust port 1106 has a passage inlet 1206 (shown in FIGS. 12-13) and a passage outlet 1118. The passage inlet 1206 is in contact with the manifold interior 1104. The valve 1020 is operable to contact or move out of contact with the passage inlet 1206 to prevent or allow fluid to flow from the manifold interior 1104 through the passage inlet 1206 along the passage 1114 and out the passage outlet 1118 to atmosphere 1116.

The passage outlet 1118 is smaller than the passage inlet 1206. With the passage outlet 1118 smaller than the passage inlet 1206, the fluid flowing through the passage 1114 increases in velocity from the manifold interior 1104 through the exhaust port 1106 to atmosphere 1116.

Referring to FIG. 13, the passage 1114 has a first portion 1302 and a second portion 1304. The first portion 1302 extends from the passage inlet 1206 into the manifold housing 1102. The second portion 1304 is coupled to the first portion 1302. The second portion 1304 extends from the first portion 1302 to the passage outlet 1118. Fluid exhausts out the manifold interior 1104 from the first portion 1302 to the second portion 1304 and out the passage outlet 1118.

In some implementations, the passage 1114 includes a frustoconical inner surface 1322 that defines a frustoconical volume. For example, as shown in FIGS. 11-13, the second portion 1304 which is proximal the passage outlet 1118 includes the frustoconical inner surface 1322 that defines a frustoconical volume. In other implementations, the entire passage 1114 can be the frustoconical volume. In other examples, the first portion 1302 can be a first frustoconical volume and the second portion 1304 can be a second frustoconical volume, with both frustoconical volumes further narrowing the passage 1114 from the passage inlet 1206 to the passage outlet 1118.

Referring to FIG. 13, the first portion 1302 has a diameter 1306 and a length 1308. In some examples, the diameter 1306 of the first portion 1302 can be between 2 and 12 millimeters, however, any appropriate diameter may be used based on other feature dimensions to increase the fluid velocity. The length 1308 of the first portion 1302 extends from the passage inlet 1206 to the second portion 1304. In some implementations, the length 1308 of the first portion 1302 can be between 0 and 10 millimeters, however, any appropriate length may be used based on other feature dimensions to increase the fluid velocity. The first portion 1302 can include a cylindrical inner surface 1324 that defines a cylindrical volume.

The second portion 1304 has a diameter 1310 and a length 1312. The length 1312 of the second portion 1304 extends from the first portion 1302 to the passage outlet 1118. The diameter 1310 and the length 1312 of the second portion 1304 are selected to decrease in diameter 1310 along the length 1312 for the deflating of the inflatable chambers 114A and 114B to decrease the turbulence and the sound of the fluid. In some cases, a drastic decrease in diameter may increase the turbulence and the sound level.

In this implementation, the length 1308 of the first portion 1302 is less than the length 1312 of the second portion 1304. However, in other implementations, the length 1308 of the first portion 1302 can be equal to or greater than the length 1312 of the second portion 1304.

The passage 1114 has a central axis 1314. The passage 1114 tapers from the passage inlet 1206 to the passage outlet 1118. Tapering the passage 1114 can increase the velocity of the fluid. In the implementation shown in FIG. 13, the second portion 1304 is tapered. The second portion 1304 tapers from the intersection 1316 of the first portion 1302 and the second portion 1304 to the passage outlet 1118. However, in other implementations, the passage 1114 can taper from the passage inlet 1206 to the passage outlet 1118. The passage 1114 tapers toward the passage outlet 1118 at an angle 1318 toward the central axis 1314.

The passage 1114 tapers from the passage inlet 1206 to the passage outlet 1118 at an angle 1318 of between 0.5 degree and 20 degrees toward a central axis 1314. However, an appropriate taper angle may be used, even above 20 degrees. In the example implementation shown in FIG. 13, the passage 1114 tapers from the transition 1316 to the passage outlet 1118 at an angle of substantially 9.6 degrees toward a central axis 1314. Alternatively, in other implementations, the passage 1114 can taper from the passage inlet 1206 to the passage outlet 1118 at an angle of substantially 9.6 degrees toward a central axis 1314.

As shown in FIG. 13, the passage 1114 can taper linearly from the transition 1316 to the passage outlet 1118. Alternatively, the passage 1114 tapers linearly from the passage inlet 1206 to the passage outlet 1118. In other implementations, the passage 1114 can taper exponentially or in a serpentine shape between the passage inlet 1206 or the transition 1316 and the passage outlet 1118.

In the example implementation shown in FIG. 13, the passage inlet 1206 has a circular cross-section defined by the diameter 1306 and the first portion 1302 is cylindrically shaped. Alternatively, the passage inlet 1206 can have an oval cross-section, a rounded rectangle cross-section, or other geometric or non-geometric shape.

The passage outlet 1118 has a diameter 1320. In the example implementation shown in FIG. 13, the passage outlet 1118 has a circular cross-section defined by the diameter 1320. Alternatively, the passage outlet 1118 can have an oval cross-section, a rounded rectangle cross-section, or other geometric or non-geometric shape.

The central axis 1314 of the exhaust port 1106 is substantially orthogonal to a plane defined by the passage outlet 1118. Alternatively, the exhaust port 1106 can be angled relative to the plane defined by the passage outlet 1118.

The central axis 1314 of the exhaust port 1106 is substantially orthogonal to the top surface 1120 of the valve manifold 1018. Alternatively, the exhaust port 1106 can be angled relative to the top surface 1120 of the valve manifold 1018.

Increasing the velocity of the fluid flowing through the passage 1114 and out the passage outlet 1118 can reduce a sound level of the fluid. The passage 1114 increases the velocity of fluid flowing from the passage inlet 1206 to the passage outlet 1118. In some implementations, the velocity can be increased by the passage 1114 between 0.5 and 0.75 times. In other implementations, increasing the velocity less than 0.5 times or more than 0.75 times can still reduce the sound level of the fluid exiting the passage 1114.

In some implementations, the sound level is reduced by half. For example, in testing the sound level was decreased from 59 dB to 52 dB, which is a decrease of 7 dB, decreasing the sound level by half. In other implementations, the sound level can be decreased between 0.25 and 0.75, however, a higher or lower level decrease can be achieved based on feature dimensions.

Accordingly, a valve for use in a pump system of a bed can have one or more other features that can reduce noise, creating a quieter operating environment. For example, a valve manifold can include one or more features or dimensions configured for regulating fluid flow during opening and closing of a valve. Relative size and positioning of various components can allow the fluid to flow in a way such that an audible noise level of the flow is reduced or the fluid flow velocity is increased in a relatively quiet manner.

A number of embodiments of the invention have been described. Nevertheless, it will be understood that various modifications may be made without departing from the spirit and scope of the invention. For example, various components illustrated in the controller 124, such as the pump 120, the manifold 143, and the printed circuit board 160, can be modified as suitable for a given application. For example, the housing 1002 is illustrated in FIG. 10 as a three piece housing, but in some embodiments it can include more or fewer pieces. Additionally, in some embodiments the valve plungers and their features described herein can be used in a system other than the bed system 100 shown and described in FIGS. 1 and 2. Moreover, one or more features present on one or more of the various embodiments can be considered optional and need not necessarily be included in all embodiments. Accordingly, other embodiments are within the scope of the following claims.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. As used herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As used herein, the term “approximately” refers to a condition or parameter which can have a value or threshold value generally within acceptable engineering, machining, measurement, or manufacturing tolerances. For example, the parameter value or threshold value can be considered approximately met when the value is within 5% of the actual parameter value or threshold value. For example, the parameter value can be considered to be equal to the threshold value when the parameter value is within 5% of the threshold value. However, different approximations for different parameter values or threshold values may be used in different embodiments.

What is claimed is:

1. A bed system comprising:
a mattress having at least one inflatable chamber;
a pump; and
a valve manifold comprising:
a manifold housing defining a manifold interior;
an inlet port passing through the manifold housing, the inlet port configured to conduct fluid from the pump to the manifold interior;
an outlet port passing through the manifold housing, the outlet port configured to conduct fluid from the manifold interior to and from the at least one inflatable chamber; and
an exhaust port passing through the manifold housing, the exhaust port defining a passage having a passage inlet and a passage outlet, wherein the passage outlet is smaller than the passage inlet.

2. The bed system of claim 1, wherein the passage comprises a first portion and a second portion.

3. The bed system of claim 2, wherein the first portion of the passage comprises a cylindrical volume and the second portion of the passage comprises a frustoconical volume.

4. The bed system of claim 3, wherein the frustoconical volume of the passage is proximal to the passage outlet.

5. The bed system of claim 2, wherein a length of the first portion is less than a length of the second portion.

6. The bed system of claim 1, wherein the passage tapers linearly from the passage inlet to the passage outlet.

7. The bed system of claim 1, wherein the passage tapers from the passage inlet to the passage outlet at an angle of substantially 9.6 degrees toward a central axis of the passage.

8. The bed system of claim 1, wherein the passage tapers exponentially from the passage inlet to the passage outlet.

9. The bed system of claim 1, wherein the passage tapers in a serpentine shape from the passage inlet to the passage outlet.

10. The bed system of claim 1, wherein a central axis of the exhaust port is substantially orthogonal to a plane defined by the passage outlet.

11. The bed system of claim 1, wherein a central axis of the exhaust port is substantially orthogonal to a top surface of the valve manifold.

12. The bed system of claim 1, wherein the passage outlet is positioned on a top surface of the valve manifold.

13. The bed system of claim 1, further comprising a housing surrounding the pump and the valve manifold, the housing defining an atmosphere within the housing, the exhaust port connecting the manifold interior to the atmosphere within the housing.

14. The bed system of claim 1, wherein the exhaust port is configured to increase a velocity of fluid flowing from the passage inlet to the passage outlet between 0.5 and 0.75 times.

15. The bed system of claim 14, wherein the exhaust port is configured to, responsive to increasing the velocity of the fluid flowing from the passage inlet to the passage outlet between 0.5 and 0.75 times reduces a sound level of the fluid exiting the passage outlet.

16. The bed system of claim 15, wherein the sound level is reduced between 0.25 and 0.75 times.

17. The bed system of claim 15, wherein the sound level is reduced to at least 7 dB.

18. The bed system of claim 1, wherein the valve manifold further comprises an exhaust valve having a valve disc configured to selectively open and close the exhaust port by contacting the passage inlet of the exhaust port.

19. A valve manifold comprising:
a manifold housing defining a manifold interior;
an inlet port passing through the manifold housing, the inlet port configured to conduct fluid to the manifold interior;
an outlet port passing through the manifold housing, the outlet port configured to conduct fluid to and from the manifold interior; and
an exhaust port passing through the manifold housing, the exhaust port having a means for increasing a velocity of fluid flowing through the exhaust port.

20. A pump system comprising:
a valve manifold comprising:
a manifold housing defining a manifold interior;
an inlet port passing through the manifold housing, the inlet port configured to conduct fluid to the manifold interior;
an outlet port passing through the manifold housing, the outlet port configured to conduct fluid to and from the manifold interior; and
an exhaust port passing through the manifold housing, the exhaust port defining a passage having a passage inlet and a passage outlet, wherein the passage outlet is smaller than the passage inlet; and
a pump fluidly connected to the inlet port.
